(19) United States
(12) Patent Application Publication
(10) Pub. No.: US 2010/0151163 A1
(43) Pub. Date: Jun. 17, 2010

(54) BLOWMOLDING APPARATUS AND METHOD

(75) Inventor: Erik Lee Skov, Akron, OH (US)

Correspondence Address: MOORE & VAN ALLEN PLLC, P.O. BOX 13706, Research Triangle Park, NC, 27709, US

(73) Assignee: RUBBERMAID INCORPORATED, Huntersville, NC (US)

(21) Appl. No.: 12/637,122

(22) Filed: Dec. 14, 2009

Related U.S. Application Data
(60) Provisional application No. 61/122,543, filed on Dec. 15, 2008.

(51) Int. Cl. B29D 22/00; B29C 49/04

(52) U.S. Cl. 428/34.1; 264/523

(57) ABSTRACT

A method of blow molding an article comprises providing a mold having a single mold cavity and a length and a width. The mold may be oriented such that the length is oriented horizontally. A first parison and a second parison are extruded into the mold cavity. The first parison and the second parison are expanded such that the material from the first parison contacts the material from the second parison to form a structural rib inside of the article. A blow molded article is also provided comprising an outer wall formed of a first parison and a second parison where a structural rib is formed where the first parison contacts the second parison. Additional parisons may be used in the same mold cavity forming additional ribs and compartments.

This application claims benefit of priority under 35 U.S.C. §119(e) to the filing date of to U.S. Provisional Application No. 61/122,543 as filed on Dec. 15, 2008, which is incorporated herein by reference in its entirety.

### FIELD OF THE INVENTION

The invention relates to blow molding and more particularly to an improved method and apparatus for blow molding an article.

### BACKGROUND

In a typical blow molding process a plastic material is heated to a molten state and is extruded through a die head and formed into a parison or preform. The parison is a tube-like piece of molten plastic open at one end. The parison is introduced into the mold cavity and the two halves of the mold close around it. A pressurized gas, typically air, is delivered to the interior of the parison through the open end of the parison via a blow pin. The gas expands the hot parison of plastic and presses it against the walls of the mold cavity. The pressure is held until the plastic cools and solidifies inside the mold cavity. The mold is opened and the formed plastic article is removed from the mold. The exterior of the article assumes the shape of the mold cavity and the interior of the article is hollow.

### SUMMARY

A method of blow molding an article comprises providing a mold having a single mold cavity and a length and a width where the width may be less than the length. The mold may be oriented such that the length is oriented horizontally or transversely to the direction of parison extrusion. A first parison and a second parison are simultaneously extruded into the mold cavity. The first parison and the second parison are expanded such that the material of the first parison contacts the material of the second parison to form a structural rib inside of the article.

The method may further include blowing a gas into the first parison and the second parison. The gas may be blown into the first parison and the second parison through a first blow pin and a second blow pin. Heat causes the material of the first parison and the material of the second parison to permanently weld together to form the structural rib. A first compartment and a second compartment may be formed by the structural rib. Additional parisons may be simultaneously extruded into the mold cavity with the first and second parisons and expanded such that the material of the additional parisons contacts the material of the first and/or second parison to form additional ribs and compartments inside of the article.

A blow molded article is also provided comprising an outer wall formed of material of a first parison and material of a second parison. A structural rib is formed where the material of the first parison contacts the material of the second parison. The material of the first parison and the material of the second parison are permanently welded together at the structural rib. The article may comprise a first compartment and a second compartment formed by the structural rib. Material of additional parisons may contact the material of the first and/or second parison to form additional ribs and additional compartments inside of the article.

### BRIEF DESCRIPTION OF THE DRAWINGS

FIG. 1 is a schematic view of an embodiment of the blow molding system of the invention with one of the mold halves removed.

FIG. 2 is a schematic view similar to FIG. 1 showing an intermediate stage of the blow molding process.

FIG. 3 is a schematic view similar to FIG. 1 showing an end stage of the blow molding process.

FIG. 4 is a section view of an article as removed from the mold in blow molding process.

FIG. 5 is a section view of a finished article.

FIG. 6 is a schematic view of another embodiment of the blow molding system of the invention with one of the mold halves removed.

FIG. 7 is a block diagram illustrating the molding method.

FIG. 8 is a cut-away view of an article.

### DETAILED DESCRIPTION OF EMBODIMENTS OF THE INVENTION

The blow molding method and apparatus allows larger articles to be blow molded without requiring larger blow molding machinery. In the blow molding technique of the invention the mold is modified to allow processing of the mold with the cavity geometry rotated from the standard orientation. Consider a mold that is a single cavity tool having a length L and a width W where the length L is greater than the width W. The mold has a single mold cavity that is rotated 90° as compared to existing systems such that the length dimension L is oriented in the mold press horizontally and the width dimension W is oriented vertically. The mold is processed with the short dimension W in-line with the direction of parison extrusion. The blow molding method and apparatus may also be used where the length dimension L and the width dimension W are the same.

In standard processing, a mold having a large horizontal direction requires a blow molding machine that has a die with a diameter size compatible with the large horizontal dimension which increases the size of the extrusion head and, in turn, greatly increases the cost of the equipment. In an existing panel mold, the mold has as single blow pin channel where the long dimension of the mold is vertically in-line with the direction of the parison extrusion. For example, consider an existing mold that is a single cavity tool with article dimensions of approximately 30″ wide by 60″ long. Using standard processing techniques this mold is processed with the length dimension (60″) in-line with the direction of parison extrusion.

With the mold redesigned for the rotated press orientation, a molding trial was conducted in a twin-head accumulator style blow molding machine with two 15 lb capacity die heads mounted 30″ apart on centerline with a mold having article dimensions of 30″×60″ where the 30″ dimension is in-line with the direction of parison extrusion. Each die head had 12″ dies installed (rather than a single die head having a 30″-35″ diameter that would otherwise be required with a 60″ wide mold) and by extruding and expanding two parisons simultaneously, a single article was produced. The blow molding technique allows plural smaller die heads to be used to make articles that would otherwise require a single larger die head resulting in cost savings.

Referring to FIG. 1, a single cavity mold 2 is provided with a mold cavity 4 having a long dimension L and a short dimension W (block 701). The parisons are extruded in a direction of parison extrusion represented by arrows A. The mold 2 is oriented with the long dimension of the mold L oriented horizontally or transversely to the direction of parison extrusion and the short dimension W oriented in-line with the direction of parison extrusion (block 702). The blow molding method and apparatus may also be used where the length dimension L and the width dimension W are the same. In such a situation either dimension may be positioned transverse to the direction of parison extrusion. Two parisons 8 and 10 of molten plastic or polymer are extruded in direction A into the cavity 4 by die heads 6 via channels 18 (block 703). Gas, typically air, is blown into the two parisons 8 and 10 via two separate blow pins 16 to expand the parisons (block 704). The parisons are extruded simultaneously or near simultaneously such that the material of both parisons is in a molten state in the mold cavity.

As the gas is introduced, the parisons 8 and 10 are expanded and the first plastic material of the first parison 8 and the second plastic material of the second parison 10 are pressed against the interior of the mold cavity 4 as shown in FIG. 2 (block 705). The terms “first plastic material” and “second plastic material” are used to distinguish the plastic material of the first parison 8 from the plastic material of the second parison 10. In practice the “first plastic material” and the “second plastic material” may and in most applications will be the same physical composition. The material of the two parisons 8 and 10 expand against the cavity walls and expand until they meet at a midpoint between the mold channels 18 (block 706). Where the first plastic material and the second plastic material meet, the heat of the molten plastic material causes this area to permanently welded together forming a structural rib 14 as shown in FIG. 3 (block 707). The structural rib 14 extends between and connects the outer walls 26 of the article 12 (block 708). The structural rib 14 provides a reinforcement structure and an inherent increase in strength of the finished article.

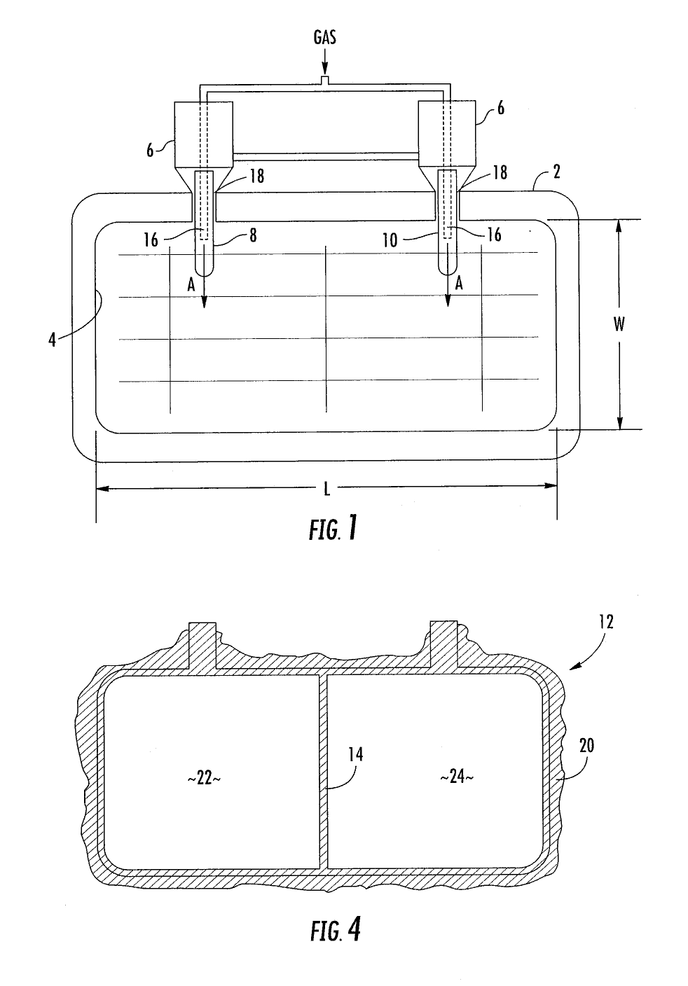

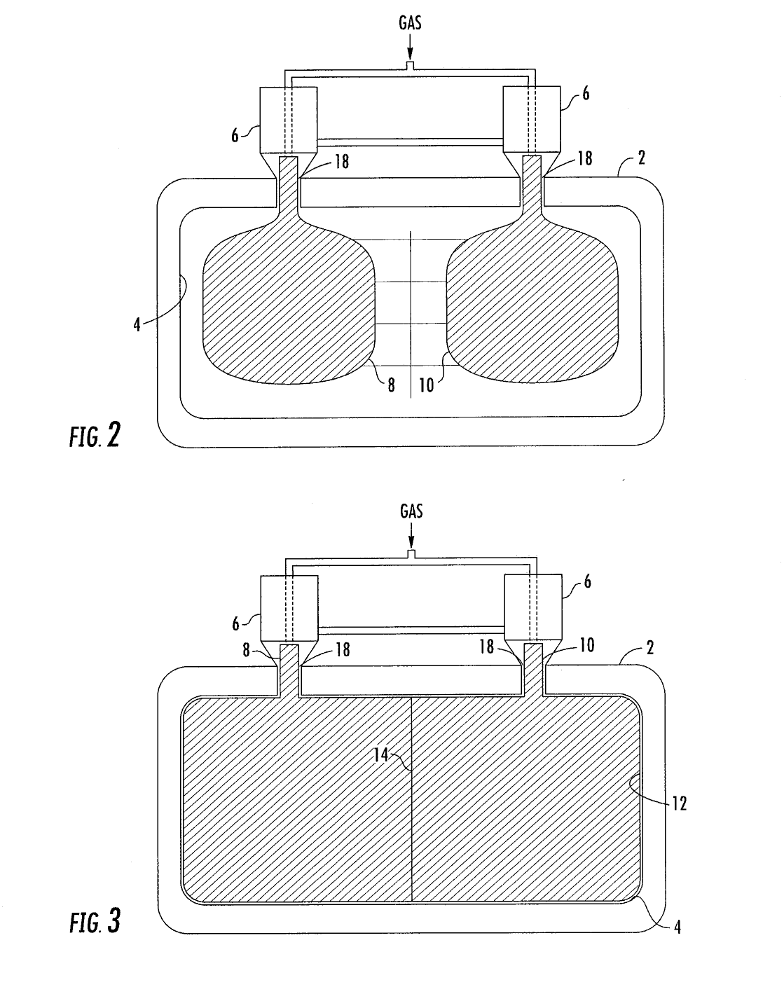

FIGS. 4, 5 and 8 show an article 12 manufactured as described herein. FIG. 4 shows article 12 as removed from the mold 2 including flashing 20. FIGS. 5 and 8 show the same article 12 with the flashing 20 removed. The exterior wall or walls 26 of article 12 conforms to the mold cavity 4 and forms a three dimensional relatively thin-walled article that is open on the interior except for ribs 14. While article 12 is shown having a particular shape and configuration, the article manufactured as described herein may have any size, shape and configuration. The interior of article 12 includes two hollow compartments 22 and 24 formed in part by the exterior wall 26 and the rib 14 where the compartments are separated by the structural rib 14. The rib 14 span the distance across the interior of article 12 such that the rib divides the interior space into the separate compartments 22 and 24. The rib 14 and the outer wall 26 form an integrated, one-piece article. The blow molding process described above provides a lower cost technique and may be used to make panels requiring higher degrees of structural strength without the need for separate metal reinforcement components because the ribs 14 form reinforced areas of plastic.

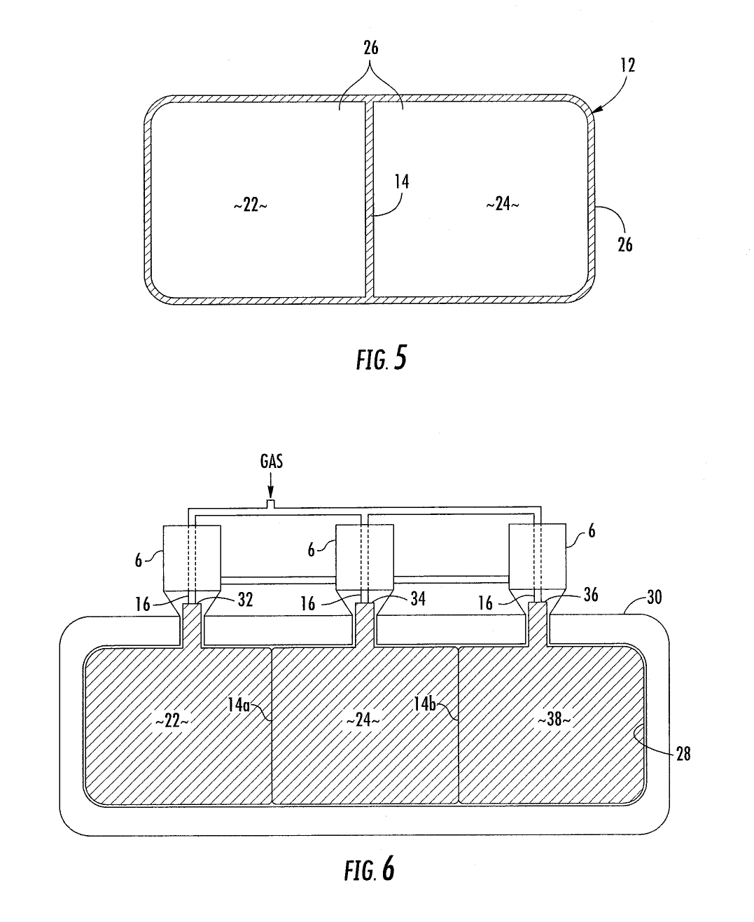

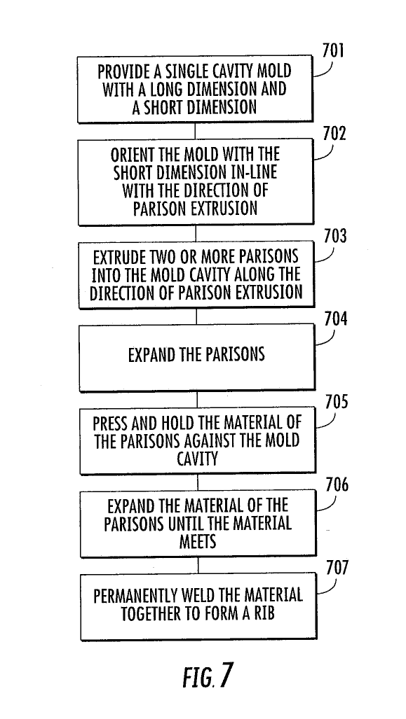

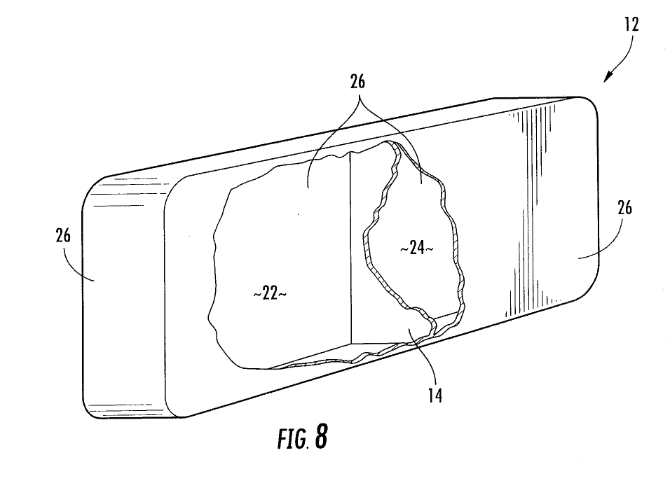

Referring to FIG. 6, a mold 30 having three parisons 32, 34 and 36 is provided such that two reinforcement ribs 14a and 14b and three compartments 22, 24 and 38 are provided in a single article 28. Additional parisons may be used to provide an article having more than two ribs and more than three compartments.

By using blow mold grade HDPE improved strength can be achieved versus using extrusion grade HDPE. The blow molding technique may also be applied to the profile extrusion process; however, this process requires additional components to close the ends of the article in order to make discreet articles. The blow molding technique provides an economic advantage because larger articles can be made with lower equipment capital and because of an improved standard cost of the finished product due to lower overhead rates from the use of a smaller blow molding machine.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A method of blow molding an article comprising:
providing a mold having a single mold cavity and a length and a width where said width is less than the length;
orienting the mold such that the length is oriented horizontally;
extruding a first parison of a first material and a second parison of a second material into the mold cavity;
expanding the first parison and the second parison such that the first material contacts the second material to form a rib inside of the article.

2. The method claim 1 further blowing a gas into the first parison and the second parison.

3. The method claim 2 wherein blowing a gas into the first parison and the second parison includes blowing gas through a first blow pin into the first parison and blowing gas through a second blow pin into the second parison.

4. The method of claim 1 wherein heat causes the first parison and the second parison to permanently weld together to form the rib.

5. The method of claim 1 further forming a first compartment and a second compartment by the rib.

6. The method of claim 1 forming an outer wall of the article with the first material and the second material.

7. The method of claim 1 extruding a third parison into the mold cavity and expanding the third parison such that the third parison contacts the second parison to form a second rib inside of the article.

8. The method of claim 7 forming a third compartment with the second rib.

9. A blow molded article comprising:
an outer wall formed of a first material from a first parison and a second material from a second parison;
a rib formed internally of the outer wall where the first material contacts the second material.

10. The article of claim 9 wherein the first material and the second material are permanently welded together at the rib.

11. The article of claim 9 further comprising a first compartment and a second compartment formed by the rib.

12. The article of claim 9 further including a third material from a third parison that contacts the second material to form a second rib inside of the article.

13. The article of claim 12 further including a third compartment formed with the second rib.

14. The article of claim 9 wherein the outer wall and the rib are one-piece.

15. The article of claim 9 wherein the outer wall is three-dimensional and is relatively thin-walled defining an open interior space except for the rib.

16. A method of blow molding an article comprising:
providing a mold having a single mold cavity and a first dimension and a second dimension said first dimension is less than the second dimension;
orienting the mold such that the first dimension is oriented in a direction in-line with a direction of parison extrusion;
extruding a first parison of a first material and a second parison of a second material into the mold cavity along said direction of parison extrusion;
expanding the first parison and the second parison such that the first material contacts the second material to form a rib inside of the article.

17. The method of claim 16 wherein the first parison and second parison are extruded simultaneously.

18. The method of claim 16 wherein the first material and the second material form an outer wall of the article, the outer wall and the rib being one-piece.

19. The method of claim 18 wherein the outer wall and the rib form a plurality of compartments interior of the outer wall.

20. A method of blow molding an article comprising:
providing a mold having a single mold cavity;
extruding a first parison of a first material and a second parison of a second material into the mold cavity;
expanding the first parison and the second parison such that the first material contacts the second material to form a rib inside of the article.
